(19) United States
(12) Patent Application Publication
(10) Pub. No.: US 2009/0123220 A1
(43) Pub. Date: May 14, 2009

(54) FIXTURE FOR ENGAGING WITH A MALE SCREW

(75) Inventor: Cheng-Hung Chou, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/100,286

(22) Filed: Apr. 9, 2008

(30) Foreign Application Priority Data
Nov. 9, 2007 (CN) 200710202448.1

(51) Int. Cl. F16B 37/04

(52) U.S. Cl. 403/21

(57) ABSTRACT

A fixture includes a plate and a female screw. The plate includes a flat base portion, and two spaced restraining portions. Each restraining portion includes an elastic finger extending from the flat base portion, and a retaining tab inwardly extending from the elastic finger at a position distant from the flat base portion. The female screw is biased to the flat base portion by the retaining tabs, and defines two grooves therein. The elastic fingers are resiliently expandable outward when the female screw is forcibly inserted therebetween, and are received in the grooves respectively when the female screw is in position.

### BACKGROUND

1. Technical Field

The present invention relates to a fixture and, particularly, to a fixture for engaging with a male screw.

2. Description of Related Art

Many devices such as cameras have one or more female screws defined in their casing, for facilitating attachment to a male screw of a positioning facility such as a tripod. In another example, a projector may define a female screw in a top panel thereof, for facilitating attachment to a ceiling.

It is well-known, that the screws in such application are usually metallic, but the portions surrounding the screws are typically made of plastic or some other weight and cost saving material. Conventionally, two ways are used to assemble the metallic female screw in the plastic portion. One way is a heated female screw is thermally bonded to the plastic, which is time-consuming and poses difficulties in accurately positioning the female screw. The other way is that a female screw is placed in a mold in advance and then assembled to the device after the plastic portion is molded. This way is also time-consuming.

What is needed, therefore, is a fixture which overcomes or at least alleviates the above-mentioned problems.

### SUMMARY

In accordance with a present embodiment, a fixture includes a plate and a female screw. The plate includes a flat base portion, and two spaced restraining portions. Each restraining portion includes an elastic finger extending from the flat base portion, and a retaining tab inwardly extending from the elastic finger at a position distant from the flat base portion. The female screw is biased to the flat base portion by the retaining tabs, and defines two grooves therein. The elastic fingers are resiliently expandable outward when the female screw is forcibly inserted therebetween, and are received in the grooves respectively when the female screw is in position.

Other advantages and novel features will be drawn from the following detailed description of at least one preferred embodiment, when considered in conjunction with the attached drawings.

### BRIEF DESCRIPTION OF THE DRAWINGS

Many aspects of the present fixture can be better understood with reference to the following drawings. The components in the drawings are not necessarily drawn to scale, the emphasis instead being placed upon clearly illustrating the principles of the present fixture. Moreover, in the drawings, like reference numerals designate corresponding parts throughout the several views.

FIG. 1 is an assembled, isometric view of a fixture, according to a first embodiment.

FIG. 2 is an exploded, isometric view of the fixture of FIG. 1.

FIG. 3 is a cross-sectional view of the fixture, taken along III-III line of FIG. 1.

FIG. 4 is a cross-sectional view of a fixture, according to a second embodiment.

### DETAILED DESCRIPTION OF THE EMBODIMENTS

Embodiments of the present fixture will now be described in detail below and with reference to the drawings.

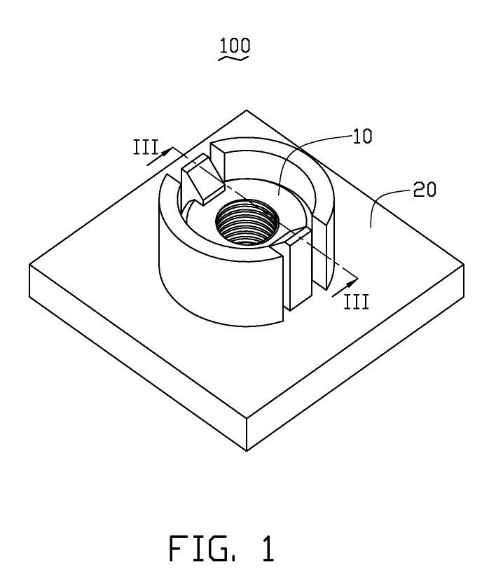

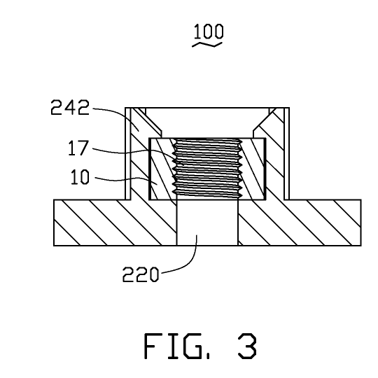

Referring to FIGS. 1-3, a fixture 100 according to a first embodiment is illustrated. The fixture 100 comprises a female screw 10, and a plate 20 firmly holding the female screw 10 thereon.

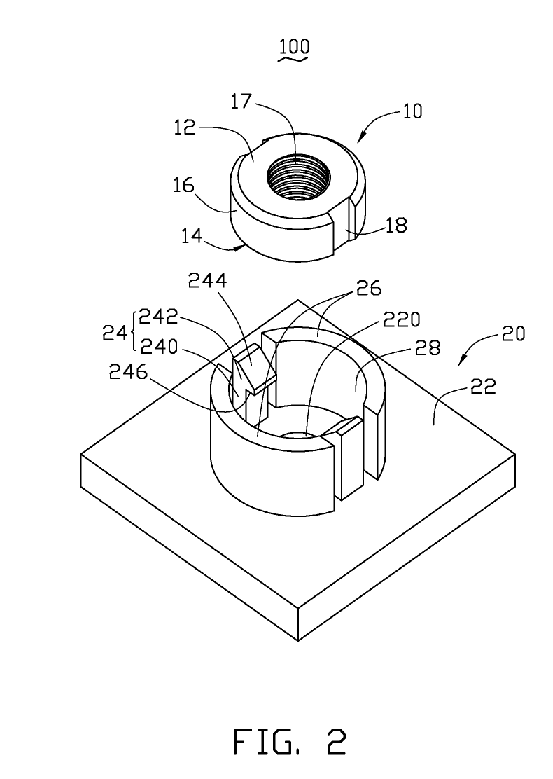

Particularly referring to FIG. 2, the female screw 10 is a hollow cylinder in the embodiment, and comprises a top surface 1 2, a bottom surface 1 4 parallel to the top surface 12, and a side surface 16 between the top and bottom surface 12, 14. The female screw 10 defines a central screw hole 1 7 extending through the female screw from top to bottom, and two grooves 18 defined in the side surface 16 extending through the top and bottom surfaces 12, 14 and symmetrically disposed at opposite sides of the side surface 16. The central screw hole 17 is configured for engaging a male screw (not shown), so that a device using the fixture can be engaged with a positioning facility having an exposed male screw, such as a tripod or a mounting apparatus on a wall or ceiling.

The panel 20 comprises a flat base portion 22, two spaced restraining portions 24 angularly extending from the flat base portion 22, and two spaced blocking walls 26 extending from the flat base portion 22 and disposed between the restraining portions 24. The flat base portion 22, the restraining portions 24, and the blocking walls 26 cooperatively define a space 28 for receiving the female screw 10 therein. The flat base portion 22 defines a through hole 220 aligned with the screw hole 17 of the female screw 10.

In the embodiment, the restraining portions 24 and the blocking walls 26 perpendicularly extend from the flat base portion 22. The restraining portions 24 each comprise an elastic finger 240 extending from the flat base portion 22, and a retaining tab 242 inwardly extending from the elastic finger 240 at a position distant from the flat base portion 22. The elastic fingers 240 are correspondingly received in the grooves 18 of the cylindrical female screw 10 in the embodiment when the female screw 10 is positioned to the plate 20. The retaining tab 242 comprises an inclined top surface 244 for guiding the female screw 10 into the space 28, and a flat bottom surface 246 for biasing the top surface 12 of the female screw toward the flat base portion 22. The blocking walls 26 in the first embodiment are arc-shaped for abutting against the side surface 16 of the female screw 10. The blocking walls 26 and the elastic fingers 240 are alternately arranged on the flat base portion 22 and surround the space 28 for receiving the female screw 10 therein.

The female screw 10 is placed on the top inclined surfaces 244 of the retaining tabs 24 and pressed toward the flat base portion 22. The elastic fingers 240 are thus expanded outwardly in response, allowing the female screw 10 to slide into the space 28. When the female screw 10 is in place in the space 28, the elastic fingers 240 rebound and the bottom surfaces 246 of the retaining tab 242 abut against the top surface 12 of the female screw 10. The retaining tabs 242 and the flat base portion 22 cooperatively keep the female screw 10 in place, and the elastic fingers 240 are received in the grooves 18 respectively, preventing the female screw 10 from sliding on the flat base portion 22 and from rotating in the space 28. The blocking walls 26 further block the female screw 10 from sliding on the flat base portion 22.

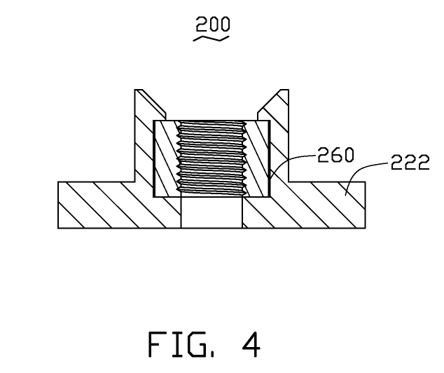

Referring to FIG. 4, a fixture 200 according to a second embodiment is illustrated. The fixture 200 is similar to the fixture 100. However, a recessed portion 260 formed on a flat base portion 222 replaces the blocking walls 26 of the first embodiment, for receiving the female screw 10 therein. Other features of the fixture 200 can be referenced from a description of the fixture 100.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A fixture comprising:
a plate comprising a flat base portion, and two spaced restraining portions, each restraining portion comprising an elastic finger extending from the flat base portion, and a retaining tab extending inwardly from the elastic finger at a position distant from the flat base portion; and
a female screw biased by the retaining tab to the flat base portion, and defining two grooves therein,
wherein the elastic fingers are resiliently expandable outward when the female screw is forcibly inserted therebetween, and are received in the grooves respectively when the female screw is in position.

2. The fixture as claimed in claim 1, wherein two blocking walls extend from the flat base portion and are disposed between the elastic fingers for abutting against a side surface of the female screw.

3. The fixture as claimed in claim 2, wherein the elastic fingers and the blocking walls are perpendicular to the flat base portion.

4. The fixture as claimed in claim 2, wherein the elastic fingers and the blocking walls are alternately arranged on the flat base portion and surround a space for receiving the female screw therein.

5. The fixture as claimed in claim 4, wherein the retaining tab comprises an inclined top surface and a bottom surface, the inclined top surface is configured for guiding the female screw into the space, and the bottom surface of the retaining tab is configured for biasing the female screw to the flat base portion.

6. The fixture as claimed in claim 1, wherein the female screw is a hollow cylinder, and the blocking walls are arc-shaped for abutting against a side surface of the female screw.

7. The fixture as claimed in claim 1, wherein the female screw defines a central screw hole therein between the grooves.

8. The fixture as claimed in claim 7, wherein the flat base portion defines a through hole therein, aligned with the central screw hole of the female screw.

9. The fixture as claimed in claim 1, wherein the flat base portion forms a recessed portion, and wherein the female screw is received in the recessed portion.
